(19) United States
(12) Patent Application Publication
(10) Pub. No.: US 2025/0136099 A1
(43) Pub. Date: May 1, 2025

(54) Method and Control Device for Operating a Vehicle with a Defect in a Single Wheel Steering Actuator

(71) Applicant: Robert Bosch GmbH, Stuttgart (DE)

(72) Inventors: Christian Riese, Stuttgart (DE); Thomas Kurz, Roemerberg (DE); Tobias Ritz, Leonberg (DE)

(21) Appl. No.: 18/792,673

(22) Filed: Aug. 2, 2024

(30) Foreign Application Priority Data
Oct. 27, 2023 (DE) 10 2023 210 662.0

(51) Int. Cl. B60W 30/09; B60W 30/095

(52) U.S. Cl. CPC B60W 30/09; B60W 30/0956; B60W 2554/80

(57) ABSTRACT

The present disclosure relates to a method for operating a vehicle with a defect on a single wheel steering actuator, wherein an avoidance direction for a steering intervention to avoid a collision is determined as a function of a speed of the vehicle and a side of the defect.

This application claims priority under 35 U.S.C. § 119 to application no. DE 10 2023 210 662.0, filed on Oct. 27, 2023 in Germany, the disclosure of which is incorporated herein by reference in its entirety.

The disclosure relates to a method for operating a vehicle with a defect in a single wheel steering actuator, a corresponding control device and a corresponding computer program product.

### BACKGROUND

A vehicle may comprise an emergency braking assistant. The emergency braking assistant can trigger emergency braking of the vehicle by means of an automated braking intervention if there is a risk of the vehicle colliding with an obstacle, for example if a driver of the vehicle does not notice the end of a traffic jam and would thus cause a collision with at least one vehicle at the end of the traffic jam.

An advanced emergency braking assistant can also trigger an avoidance maneuver of the vehicle by means of an automated steering intervention in order to avoid the obstacle laterally and avoid an otherwise unavoidable collision or to have to brake less hard. The advanced emergency braking assistant can steer the vehicle into a free lane next to the end of the traffic jam, for example, and thus prevent the collision.

### SUMMARY

With this in mind, the approach presented here introduces a method for operating a vehicle with a defect in a single wheel steering actuator, a corresponding control device and a corresponding computer program product according to the disclosure. Advantageous further developments and improvements of the approach presented here will emerge from the description and are described in the disclosure.

On a two-track vehicle, two wheels are typically provided on the same axle and can each be steered. Each wheel is typically assigned its own single wheel steering actuator. The vehicle therefore generally comprises two independently operating and controllable single wheel steering actuators.

If there is a defect in a single wheel steering actuator of a vehicle, the steering capability of the vehicle may be limited. The vehicle may steer less strongly in one direction than in the other, for instance. As a result, swerving to avoid a collision may no longer be unrestrictedly possible.

The approach presented here takes advantage of the fact that, depending on how fast the vehicle is traveling, the vehicle can be steered more easily toward the side with the defect or steered more easily away from the defect. Therefore, in the approach presented here, the defect is noted and taken into account along with a speed of the vehicle when planning the trajectory for the vehicle.

The approach presented here makes it possible to predefine an appropriate avoidance direction for the current speed. This prevents a planned avoidance trajectory not being implementable. If the speed changes, the avoidance direction can change as well.

A method for operating a vehicle with a defect in a single wheel steering actuator is presented, wherein an avoidance direction for a steering intervention to avoid a collision is determined as a function of a speed and/or lateral acceleration of the vehicle and a side of the defect.

Ideas concerning embodiments of the present disclosure may be regarded as being based, among other things, on the thoughts and findings described below.

A vehicle with single wheel steering actuators can comprise a right single wheel steering actuator and a left single wheel steering actuator on one steered axle. The vehicle can also have single wheel steering actuators on multiple axles. Each single wheel steering actuator acts on a specific steerable wheel of the vehicle. The single wheel steering actuators or the wheels of the steered axle are not mechanically coupled to one another or to a steering wheel of the vehicle in terms of steering. The single wheel steering actuators are controlled by a central sensor on the steering wheel or a steering lever of the vehicle via data signals.

If one of the single wheel steering actuators is defective, the other single wheel steering actuator is generally not affected. If there is a defect, the single wheel steering actuator may be completely inoperative or just functionally limited. If the single wheel steering actuator is completely inoperative, it cannot exert any or only a minimal steering torque on the wheel. The defective single wheel steering actuator can also exert a small inhibiting torque on the wheel. If the single wheel steering actuator is functionally limited, it can exert a reduced steering torque on the wheel, for example, and/or apply a reduced actuating speed.

If one of the single wheel steering actuators is defective, essentially only the wheel coupled to the other single wheel steering actuator can still be actively steered. If the vehicle is rolling and the wheel with the defective single wheel steering actuator is rolling freely or only small torques are acting on the wheel, the wheel with the defective single wheel steering actuator can center itself via its caster, i.e. essentially adapt its angle to a direction of movement of the vehicle. If external torques such as a drive torque or braking torque on the wheel with the defective single wheel steering actuator exceed the self-centering torque and/or the inhibiting torque of the defective single wheel steering actuator, or if too high a steering angle is set via the intact actuator when the centering forces are too low, the wheel can turn in and its angle can therefore deviate from the direction of movement of the vehicle, i.e. be aligned at an angle or transverse to the direction of movement.

When the vehicle is driving and the wheel coupled to the functioning single wheel steering actuator is being steered, tight steering radii, such as for avoiding an obstacle to avoid a collision, can be steered more easily toward the side of the defective single wheel steering actuator or more easily to the side of the functioning single wheel steering actuator depending on the speed of the vehicle. An avoidance direction can therefore be selected depending on the speed. The avoidance direction can also be determined continuously as the preferred avoidance direction as a function of the speed, even if there is no situation in which the vehicle has to take evasive action. The avoidance direction can be stored in a memory, for example, and read out in the event that an avoidance maneuver is needed. The stored avoidance direction can change as a function of the speed.

The avoidance direction can further be determined as a function of a distance to a collision object. A collision object can be a stationary or slow-moving vehicle in a lane or on a trajectory of the vehicle, for example. The collision object can be a vehicle at the end of a traffic jam in front of the vehicle, for example. The vehicle can also be a vehicle that suddenly reduces its speed, for example because it unexpectedly has to brake hard or is being involved in an accident. A distance to the collision object specifies a necessary turning radius for successful avoidance. The smaller the distance, the smaller or tighter the turning radius has to be when evading. The collision object can also be a potential collision object, i.e. a preceding vehicle. The avoidance direction can be stored in the memory in case avoidance is needed.

At a speed less than a threshold value, the avoidance direction can be determined away from the side of the defect. At a distance greater than a distance value, the avoidance direction can alternatively or additionally be determined away from the side of the defect. A “side of the defect” or the “side of the defective single wheel steering actuator” is understood to mean the side of the vehicle on which the defective single wheel steering actuator is disposed. At low speeds and large turning radii, i.e. in the case of less dynamic avoidance maneuvers, a wheel of the vehicle on the inside of the turn determines the lane, i.e. determines the direction in which the vehicle is traveling. A wheel on the outside of the turn can follow by means of its caster. If the distance is large enough, evasive action can be taken with a large turning radius. Above the threshold value and/or below the distance value, a lateral acceleration of 4 m/s², for example, can be exceeded.

At a speed greater than the threshold value, the avoidance direction can be determined toward the side of the defect. At a distance smaller than the distance value, the avoidance direction can alternatively or additionally be determined toward the side of the defect. At high speeds and small turning radii, i.e. in the case of more dynamic avoidance maneuvers, the vehicle starts to wobble and a wheel on the outside of the turn of the vehicle is loaded, while a wheel on the inside of the turn is unloaded. As a result, more lateral guiding force can be transferred to the ground at the wheel on the outside of the turn than at the wheel on the inside of the turn. Thus, in the case of the more dynamic avoidance maneuvers, the wheel of the vehicle on the outside of the turn determines the lane and determines the direction in which the vehicle is traveling.

The steering intervention can be classified as unsuitable if a needed avoidance space in the preferred avoidance direction is occupied. An avoidance space for the avoidance maneuver can be to the right or to the left of the collision object. The avoidance space can in particular be in a lane or on a shoulder to the right or to the left of the collision object. A sensor system of the vehicle can monitor the surroundings of the vehicle. The sensor system can monitor the avoidance space. If another vehicle or another obstacle is detected in the avoidance space, the vehicle would cause an alternative collision when swerving into the avoidance space to avoid the collision object. If another vehicle or another obstacle is detected in the avoidance space, the avoidance space can be identified as being occupied. The alternative collision can thus be prevented. The avoidance spaces can be monitored continuously, and the avoidance spaces can be stored in a memory as currently occupied or currently free.

It is also possible to set an intervention distance for a braking intervention to avoid the collision as a function of the speed, an available avoidance space and the side of the defect. An intervention distance can be a distance to the collision object from which an automated braking intervention is triggered to avoid the collision. The intervention distance can be increased when the defect is detected. The intervention distance can increase as the speed increases. If the avoidance space is identified as being occupied, the intervention distance can be further increased in order to prevent or at least mitigate the collision even without avoidance.

The method is preferably computer-implemented and can be implemented in software or hardware, for instance, or in a mixed form of software and hardware, for example in a driver assistance system.

The approach presented here also creates a control device, wherein the control device is configured to carry out, control or implement the steps of a variant of the method presented here in corresponding devices.

The control device can be an electrical device comprising at least one computing unit for processing signals or data, at least one memory unit for storing signals or data and at least one interface and/or communication interface for reading in or outputting data embedded in a communication protocol. The computing unit can, for instance, be a signal processor, a so-called system ASIC or a microcontroller for processing sensor signals and outputting data signals as a function of the sensor signals. The memory unit can be a flash memory, an EPROM or a magnetic memory unit, for example. The interface can be configured as a sensor interface for reading in the sensor signals from a sensor and/or as an actuator interface for outputting the data signals and/or control signals to an actuator. The communication interface can be configured to read in or output the data wirelessly and/or by wire. The interfaces can also be software modules that are provided on a microcontroller alongside other software modules, for example.

A computer program product or a computer program comprising program code that can be stored on a machine-readable carrier or storage medium, such as a semiconductor memory, a hard disk memory or an optical memory, and can be used to carry out, implement and/or control the steps of the method according to one of the above-described embodiments is advantageous as well, in particular when the program product or program is executed on a computer, in a control device or an apparatus.

It should be noted that some of the possible features and advantages of the disclosure are described here with reference to different embodiments. A person skilled in the art will recognize that the features of the control device and the method can be suitably combined, adapted, or interchanged to arrive at further embodiments of the disclosure.

### BRIEF DESCRIPTION OF THE DRAWINGS

Embodiments of the disclosure are described in the following with reference to the accompanying drawings, wherein neither the drawings nor the description are to be construed as limiting the disclosure.

FIGS. 1 and 2 show illustrations of a vehicle with a defective single wheel steering actuator and different speeds when initiating an avoidance maneuver using a method according to an embodiment example.

The figures are merely schematic and are not to scale. Identical reference signs denote identical or functionally identical features.

### DETAILED DESCRIPTION

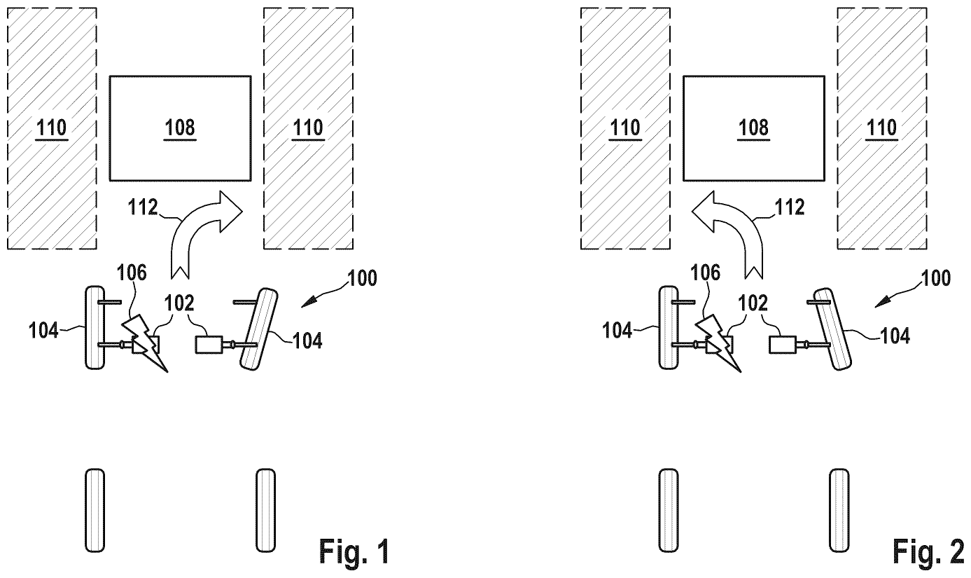

FIG. 1 shows an illustration of a vehicle 100 with a defective single wheel steering actuator 102 and low speed when initiating an avoidance maneuver using a method according to an embodiment example.

FIG. 2 shows an illustration of a vehicle 100 with a defective single wheel steering actuator 102 and high speed when initiating an avoidance maneuver using a method according to an embodiment example.

In both figures, the vehicle 100 comprises front wheels 104 which are steered via a respective single wheel steering actuator 102. In the shown examples, the left single wheel steering actuator 102 has a defect 106. The right single wheel steering actuator 102 is fully functional. The defective single wheel steering actuator 102 is unable to exert any steering torque on the left front wheel 104. Due to the defect 106, the single wheel steering actuator could alternatively also only provide a reduced steering torque. The defective single wheel steering actuator 102 then exerts only a low holding torque on the left front wheel 104. The left front wheel 104 can therefore adapt its steering angle to a direction of movement of the vehicle 100 via its caster when the vehicle 100 is rolling, if a torque generated by the caster is greater than the holding torque and an external torque generated by braking or driving the front wheel 104.

In both figures, the vehicle 100 is driving toward a collision object 108 or obstacle. The collision object 108 here is a stationary truck, for instance. If the vehicle 100 does not brake and/or swerve it will collide with the collision object 108. The available braking distance to the collision object 108 may already be so small that a collision may occur despite an emergency braking intervention. By swerving into an avoidance space 110 adjacent to the collision object 108, the collision can be prevented and the emergency braking intervention can take place with a reduced braking torque because an extended braking distance is available due to the avoidance space 110.

In FIG. 1, the vehicle 100 is traveling at low speed. The low speed results in a less dynamic avoidance maneuver, in which the weight of the vehicle 100 shifts only slightly onto the wheels of the vehicle on the outside of the turn. Therefore the front wheel 104 on the inside of the turn determines the lane at the low speed.

In FIG. 2, the vehicle 100 is traveling at higher speed. The higher speed results in a dynamic avoidance maneuver, in which a large portion of the weight of the vehicle 100 shifts to the front wheel 104 on the outside of the turn and the front wheel 104 on the inside of the turn is unloaded. Therefore the front wheel 104 on the outside of the turn determines the lane at the higher speed.

Since the speed specifies which side determines the lane, in the approach presented here an avoidance direction 112 is determined for the avoidance maneuver based on the side of the defect 106 and the speed. The avoidance direction 112 is specified such that the functional single wheel steering actuator 102 is on the lane-determining side and the single wheel steering actuator 102 with the defect 106 is on the non-lane-determining side. The avoidance direction 112 can be determined continuously and called up if a risk of collision is identified. This saves the time needed to make a determination.

In one embodiment example, the wheel on the inside of the turn is assumed to determine the lane at a speed below a threshold value, and the wheel on the outside of the turn is assumed to determine the lane at a speed above the threshold value. Accordingly, the avoidance direction 112 is determined away from the side of the defect 106 at the speed less than the threshold value and toward the side of the defect 106 at the speed greater than the threshold value.

In one embodiment example the avoidance direction 112 is further determined using a distance to the collision object 108. The closer the vehicle 100 is to the collision object 108 when the risk of collision is identified, the more dynamically the avoidance maneuver has to be carried out to be successful. The threshold value for the speed can be reduced as the distance decreases, for instance.

In one embodiment example an avoidance direction 112 is determined only when the avoidance space 110 in that avoidance direction 112 is free. If the avoidance space 110 in the avoidance direction 112 is occupied, no avoidance direction 112 is stored and, if there is a risk of collision, emergency braking is carried out without avoidance.

In one embodiment example an intervention distance for the avoidance maneuver is set as a function of the side of the defect 106, the speed and the available avoidance space 110. If the avoidance space 110 is available only on the side opposite the defect 106, for example, it is not possible to carry out a dynamic avoidance maneuver toward the side of the defect 106. To nonetheless be able to take evasive action, a less dynamic avoidance maneuver away from the side of the defect 106 has to be carried out. The less dynamic avoidance maneuver can be carried out only when the distance to the collision object is increased 108, i.e. when the intervention distance is increased. When the avoidance space 110 on the side of the defect 106 is free again, the intervention distance can be reduced again.

Possible embodiments of the disclosure are summarized again below or presented with a slightly different choice of words.

An operating strategy for speed-dependent control of single wheel steering actuators with a failed or degraded steering actuator is presented.

Modern vehicles are equipped with electromechanical steering connected to both wheels. The development of steering systems is moving more and more in the direction of by-wire systems that are mechanically decoupled from the driver. This eliminates the classic mechanical connection between the driver and the wheels themselves via the steering wheel. In the case of the steering, the respective actuation takes place purely via one or more actuators. Both centralized and decentralized by-wire steering actuators are already being installed on the rear axle. The first prototype vehicles with by-wire single wheel steering actuators for the front axle, such as the research vehicle SpeedE, are well-known.

A driver assistance function called automated collision avoidance (ACA) can provide support in dangerous situations, such as when the driver notices the end of a traffic jam too late. Unlike a conventional emergency braking function, this system can automatically allow the vehicle swerve into a free lane if there is not enough space inside the current lane for emergency braking. If the distance to the end of the traffic jam is large enough, the assistance system stops the car with conventional emergency braking. Automatic collision avoidance can assist the driver on freeways up to a speed of 130 km/h.

In the future, the NCAP test will include the requirements for automated avoidance.

Up until now, there has not been an optimal control strategy for avoidance for single wheel steering actuators in the event of a failure of an actuator. Strategies for handling the drive and the brake in the event of a failure of a single wheel steering actuator can take into account the partially reduced braking capacity on the failed steering actuator side. This can make avoidance even more relevant, because the braking capacity is reduced in order to prevent the wheel with the defective actuator from turning in/turning away.

The approach presented here makes us of the fact that different optimal controls result for the remaining single wheel steering actuator depending on the speed or lateral acceleration and the associated shift in the wheel load.

During less dynamic driving with lateral accelerations <4 m/s2, the inner wheel is lane-dominant, i.e. determinative for the trajectory being driven, when the vehicle is turning due to the steering geometry designed in accordance with Ackermann.

At a correspondingly high speed or tight turning radius, the wheel on the outside of the turn is lane-dominant due to the dynamic wheel load shift (rolling).

When approaching the end of a traffic jam, for example, this means that, depending on on which side the actuator has failed, swerving to one side (to the left or the right of the end of the traffic jam) could result in a collision, but swerving to the other side would not. As a result of a tighter turning radius, for example, this could moreover also leave more distance to initiate further measures.

The approach presented here makes it possible to provide this information to an emergency braking assistant, so that it knows from which point in time onward only full braking is possible and also to which side avoidance is still successfully possible. These measures can be used to ascertain remaining periods of time when approaching an obstacle that can be entered into the emergency braking assistant.

If the distance is sufficient, swerving and braking in both directions is possible.

If the distance is too small, swerving and braking only to one side is still successfully possible. The failed steering actuator side is taken into account.

If only emergency braking is still possible, the operating strategy presented here improves the residual performance in the event of a system failure and thus increases safety.

Applied to single wheel steering actuators, this means that, when approaching a stationary obstacle, for example, with a failed steering actuator on the left, swerving to the right is advantageous at low speeds or lateral acceleration due to purely kinematic steering effects without wheel load shift, because the remaining right wheel on the inside of the turn enables stronger steering. At higher speed or lateral acceleration, swerving to the left is advantageous in terms of the achievable turning radius, because the wheel on the outside of the turn becomes dominant with respect to lane guidance.

Information from the surroundings sensor system can be entered into the function presented here as well, in order to identify respective permissible avoidance trajectories and ascertain the minimum necessary but maximum possible dynamics. If the ideal avoidance direction is not permissible, e.g. due to preceding or following traffic, it is possible to either select the non-preferred direction or forego avoidance and prioritize braking with maximum deceleration. Alternatively, a measure such as braking can be initiated correspondingly earlier.

Using the example of the left actuator fail passive failed, swerving to the right takes place at low speed/lateral acceleration and swerving to the left takes place at high speed/lateral acceleration.

The operating strategy presented here can also be used for a degraded single wheel steering actuator, e.g. with 50% steering torque remaining, if it is no longer sufficient to appropriately dynamically apply the target steering angle.

The operating strategy presented here can moreover also be used for steer-by-wire and EPS central controllers.

Lastly, it should be noted that terms such as “comprising”, “including”, etc. do not exclude other elements or steps and terms such as “one” or “a” do not exclude a plurality.

What is claimed is:

1. A method for operating a vehicle with a defect on a single wheel steering actuator, comprising:
determining an avoidance direction for a steering intervention to avoid a collision as a function of a speed of the vehicle and a side of the defect on the single wheel steering actuator.

2. The method according to claim 1 in which the avoidance direction is further determined as a function of a distance to a collision object.

3. The method according to claim 1, further comprising:
determining that the speed of the vehicle is less than a threshold value and/or determining that a distance to a collision object is greater than a distance value, wherein determining the avoidance direction for the steering intervention comprises:
determining the avoidance direction to be away from the side of the defect in response to the determining that the speed of the vehicle is less than the threshold value and/or determining that the distance to the collision object is greater than the distance value.

4. The method according to claim 1, further comprising:
determining that the speed of the vehicle is greater than a threshold value and/or determining that a distance to a collision object is smaller than a distance value, wherein determining the avoidance direction for the steering intervention comprises:
determining the avoidance direction to be toward the side of the defect in response to the determining that the speed of the vehicle is greater than the threshold value and/or determining that the distance to the collision object is smaller than the distance value.

5. The method according to claim 1, in which the steering intervention is classified as unsuitable if a needed avoidance space in the determined avoidance direction is occupied.

6. The method according to claim 1, in which an intervention distance for a braking intervention to avoid the collision is set as a function of the speed, an available avoidance space and the side of the defect.

7. The method according to claim 6 in which the intervention distance is increased when the available avoidance space is occupied.

8. A control device, wherein the control device is configured to execute, implement and/or control the method according to claim 1.

9. A computer program product which is configured to direct a processor to execute, implement and/or control the method according to one of claim 1 when said computer program product is executed.

10. A machine-readable storage medium on which the computer program product according to claim 9 is stored.
